(19) United States
(12) Patent Application Publication
(10) Pub. No.: US 2026/0253972 A1
(43) Pub. Date: Aug. 27, 2026

(54) BATTERY MODULE

(71) Applicant: Panasonic Intellectual Property Management Co., Ltd., Osaka (JP)

(72) Inventors: Motomasa INUI, Osaka (JP); Takashi MATSUSHIGE, Osaka (JP)

(21) Appl. No.: 19/324,719

(22) Filed: Sep. 10, 2025

Related U.S. Application Data
(63) Continuation of application No. PCT/JP2025/019974, filed on Jun. 3, 2025.

(30) Foreign Application Priority Data
Feb. 25, 2025 (JP) 2025-028156

(51) Int. Cl. H01M 10/42; H01M 10/48; H01M 10/613; H01M 10/6563

(52) U.S. Cl. CPC H01M 10/4228; H01M 10/48; H01M 10/613; H01M 10/6563

(57) ABSTRACT

A battery module comprises: an exterior casing; a battery assembly that is housed in the exterior casing; an inlet that is provided to an end wall of the exterior casing; a fan that is mounted on an inner surface of the end wall, and that is configured to blow out air suctioned through the inlet into the exterior casing; a standing wall that has a facing surface facing the fan, and a guide rib projecting from a lower part of the facing surface toward the fan; and a leakage sensor extending along the facing surface, with at least a part of the leakage sensor disposed along the guide rib.

### CROSS REFERENCE TO RELATED APPLICATION

This is a continuation application claiming priority of International Patent Application No. PCT/JP2025/019974 with an international filing date of June 3, 2025, which claims priority of Japanese Patent Application No. 2025-028156 filed on February 25, 2025, the entire contents of which are incorporated herein by reference.

### BACKGROUND

### Technical Field

The present disclosure relates to a battery module.

### Background Art

WO 2018/123573 A discloses a battery module in which a plurality of battery cells are housed in a casing. This battery module includes a fan for cooling a heat-generating component, such as a battery cell, using the air. This casing has an entrance and an exit through which the cooling air is passed, and the entrance and the exit are configured as a plurality of through holes.

### SUMMARY

As an example of a configuration of use of the battery module, one or more of such battery modules are disposed on a shelf in alignment with a liquid-cooled electronic device. In case of leakage of the coolant, the coolant may go into the casing of the battery module through the entrance or the exit for the cooling air. In other usage configurations, there is also a risk of ingress of liquid.

An object of the present disclosure is to provide a battery module capable of accurately detecting the ingress of liquid.

One aspect of the present disclosure provides a battery module comprising: an exterior casing; a battery assembly that is housed in the exterior casing; an inlet that is provided to an end wall of the exterior casing; a fan that is mounted on an inner surface of the end wall, and that is configured to blow out air suctioned through the inlet into the exterior casing; a standing wall that has a facing surface facing the fan, and a guide rib projecting from a lower part of the facing surface toward the fan; and a leakage sensor extending along the facing surface, with at least a part of the leakage sensor disposed along the guide rib.

According to the present disclosure, it is possible to provide a battery module capable of accurately detecting the ingress of liquid.

### BRIEF DESCRIPTION OF THE DRAWINGS

FIG. 1 is a perspective view of a battery module according to a first embodiment.

FIG. 2 is a partial cross-sectional view of the battery module in FIG. 1.

FIG. 3 is an exploded perspective view of the battery module in FIG. 1.

FIG. 4 is an exploded perspective view of the battery module in FIG. 1.

FIG. 5 is an exploded perspective view of a fan, a leakage sensor, and a standing wall in FIG. 4.

FIG. 6 is a perspective view of the leakage sensor and the standing wall in FIG. 5.

FIG. 7 is a front view of the leakage sensor and the standing wall in FIG. 5.

FIG. 8 is an exploded perspective view of a fan, a leakage sensor, and a standing wall in a battery module according to a second embodiment.

FIG. 9 is a perspective view of the leakage sensor and the standing wall in FIG. 8.

FIG. 10 is a front view of the leakage sensor and the standing wall in FIG. 8.

### DETAILED DESCRIPTION

Embodiments will now be explained with reference to drawings. Note that the same or corresponding elements are denoted by the same reference numerals throughout the drawings, and redundant detailed descriptions will be omitted hereunder.

In an embodiment of the present disclosure, a battery module includes: an exterior casing; a battery assembly that is housed in the exterior casing; an inlet that is provided to an end wall of the exterior casing; a fan that is mounted on an inner surface of the end wall, and that is configured to blow out air suctioned through the inlet into the exterior casing; a standing wall that has a facing surface facing the fan, and a guide rib projecting from a lower part of the facing surface toward the fan; and a leakage sensor extending along the facing surface, with at least a part of the leakage sensor disposed along the guide rib.

With such a configuration, it is possible to cool the heat-generating component, such as the battery assembly, with the air sent out of the fan. However, the airflow generated by the fan may also carry liquid from the outside into the exterior casing through the inlet. The fan is disposed to faces the facing surface of the standing wall. Therefore, the liquid suctioned into the fan is blown against the facing surface. The leakage sensor extends along this facing surface. As a result, when the liquid is blown by the fan, the leakage sensor can suitably sense the ingress of liquid.

When the amount of ingress liquid is small, the liquid tends to be blown out as mist. When the liquid is blown against the leakage sensor as mist, the leakage sensor may fail to accurately sense that the liquid is being blown. However, the facing surface of the standing wall receives the mist, and the mist becomes attached to the facing surface, and forms droplets. With the weight of the droplets themselves, the droplets flow down along the facing surface, while gathering other droplets attached to a lower part of the facing surface and increasing size. On the lower part of the facing surface, a guide rib is provided. The droplets are guided along the guide rib, and become gathered to the lower part of the facing surface. At least a part of the leakage sensor is disposed along such a guide rib, so that the liquid droplets gathered can be sensed suitably. In other words, even when the amount of ingress liquid is small, the leakage sensor can detect the ingress of the liquid accurately.

In a battery module according to another embodiment of the present disclosure, the leakage sensor may include a laterally extending part extending in a width direction, along the bottom edge of the facing surface.

With such a configuration, because the laterally extending part extends in the width direction along the bottom edge of the facing surface, the droplets gathered in the lower part of the facing surface are allowed to come into contact with the laterally extending part, more suitably. Therefore, the detection accuracy of the ingress of liquid can be improved.

In a battery module according to another embodiment of the present disclosure, the guide rib may include a curved rib curving downward toward a center of the facing surface in the width direction; and the laterally extending part may be provided along an inner surface of the curved rib.

With such a configuration, droplets are guided along the inner surface of the curved rib to the lower part of the facing surface, near the center in the width direction. Droplets thus gathered are allowed to come into contact with the laterally extending part, which is provided along the inner surface of the curved rib, more easily. Therefore, the detection accuracy of the ingress of liquid can be improved.

In a battery module according to another embodiment of the present disclosure, the guide rib may include an inclined rib inclined downward toward the center in the width direction, and being continuous with a top end of the curved rib.

With such a configuration, the inclined rib can receive the droplets from a wide range of the facing surface, and guide the received droplets to the curved rib. In this manner, it is possible to increase the amount of droplets collected to the curved rib, that is, to increase the amount of droplets brought into contact with the laterally extending part. Therefore, the detection accuracy of the ingress of liquid can be improved.

In a battery module according to another embodiment of the present disclosure, the leakage sensor may include: a first vertically extending part extending upward from an end of the laterally extending part, on one side in the width direction; and a second vertically extending part extending upward from an end of the laterally extending part, on the other side in the width direction.

With such a configuration, with the presence of the first vertically extending part and the second vertically extending part, the leakage sensor can cover a wider range of the facing surface. Therefore, the detection accuracy of the ingress of liquid can be improved. A part of the liquid is directly blown against the first vertically extending part and the second vertically extending part. Therefore, when there is a large amount of ingress liquid, the first vertically extending part and the second vertically extending part are allowed to sense the ingress of the liquid sufficiently without waiting for the droplets flowing downward, so that the ingress of liquid can be detected quickly.

In a battery module according to another embodiment of the present disclosure, the guide rib may include a first vertical rib and a second vertical rib that are spaced apart from each other in the width direction, and that extend in the vertical direction; and the first vertically extending part may be disposed along an inner surface of the first vertical rib, and the second vertically extending part may be disposed along an inner surface of the second vertical rib.

With such a configuration, the droplets are gathered at the lower part of the facing surface, by being guided along the inner surfaces of the first vertical rib or the second vertical rib. The droplets thus gathered are better allowed to come into contact with the first vertically extending part and the second vertically extending part that are disposed along the inner surfaces of the respective vertical ribs. Therefore, the detection accuracy of the ingress of liquid can be improved.

In a battery module according to another embodiment of the present disclosure, a first sleeve having a cylindrical shape may be disposed around a connection between the first vertically extending part and a signal line; an upper end of the first vertically extending part may be bent toward another side in the width direction; and the first sleeve may extend from the first vertically extending part to the other side in the width direction along an upper edge of the facing surface.

With such a configuration, the first sleeve is disposed along the upper edge of the facing surface, that is, the part that hardly contributes to the accumulation of the droplets on the facing surface. Therefore, the largest possible area of the facing surface is enabled to receive the liquid, so that the amount of droplets collected by the guide rib is increased, accordingly. Therefore, the detection accuracy of the ingress of liquid can be improved.

In a battery module according to another embodiment of the present disclosure, a second sleeve having a cylindrical shape may be disposed around a connection between the second vertically extending part and a signal line; an upper end of the second vertically extending part may be folded downward; and the second sleeve may extend downward from the second vertically extending part, adjacently to the second vertically extending part on the other side in the width direction.

With such a configuration, the second sleeve extends in the vertical direction. With the second sleeve, the downward flow of the droplets along the facing surface is hardly obstructed. The amount of droplets collected by the guide rib can therefore be ensured, so that the detection accuracy of the ingress of liquid can be improved.

In a battery module according to another embodiment of the present disclosure, the standing wall may be a component separate from the battery assembly, and interposed between the fan and the battery assembly.

With such a configuration, because the standing wall is a component separate from the battery assembly, the shape of the standing wall and the positioning of the leakage sensor can be better optimized for the purpose of accumulating liquid. Therefore, the detection accuracy of the ingress of liquid can be improved.

Specific examples of the present disclosure will now be described in detail with reference to the drawings. In the following description, terms indicating specific directions or positions (e.g., terms including “up”, “down”, and other words including such terms) are used as necessary. These terms are intended to facilitate the understanding of the present disclosure with reference to the drawings, but are not intended to limit the technical scope of the present disclosure to their meanings. Parts denoted by the same reference numerals across a plurality of drawings are the same or equivalent parts or members. Furthermore, the following embodiments are intended to describe specific examples of the technical idea of the present disclosure, but are not intended to limit the present disclosure to what is described below. In addition, dimensions, materials, shapes, relative arrangements, and the like of the components described below are not intended to limit the scope of the present disclosure only thereto, unless specified otherwise, and are intended to be illustrative in nature. The description in one embodiment or one example is also applicable to the other embodiments and examples. In addition, sizes, positional relationships, and the like of members illustrated in the drawings may be exaggerated for the clarity of description.

The battery module according to the present disclosure is applied to an emergency power supply such as a battery backup unit (BBU), for example. However, the present disclosure does not specify the application of the battery module, and may also be used as a power source for various other electric devices such as the power source for the driving motor of a vehicle.

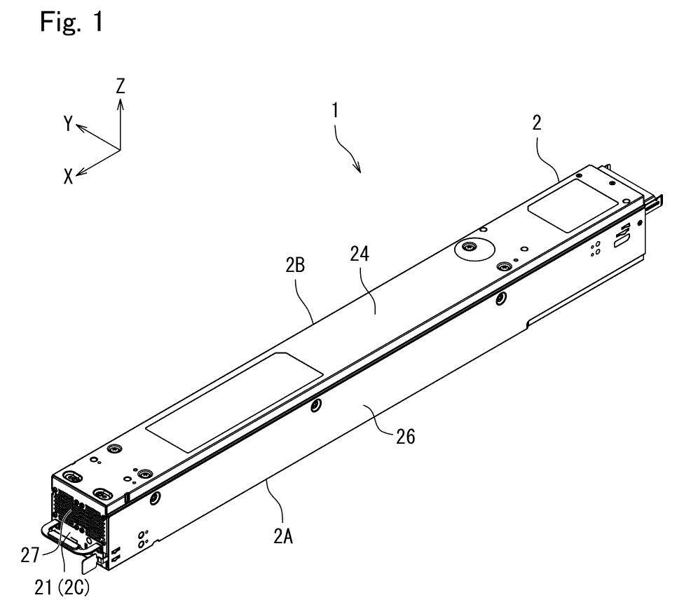

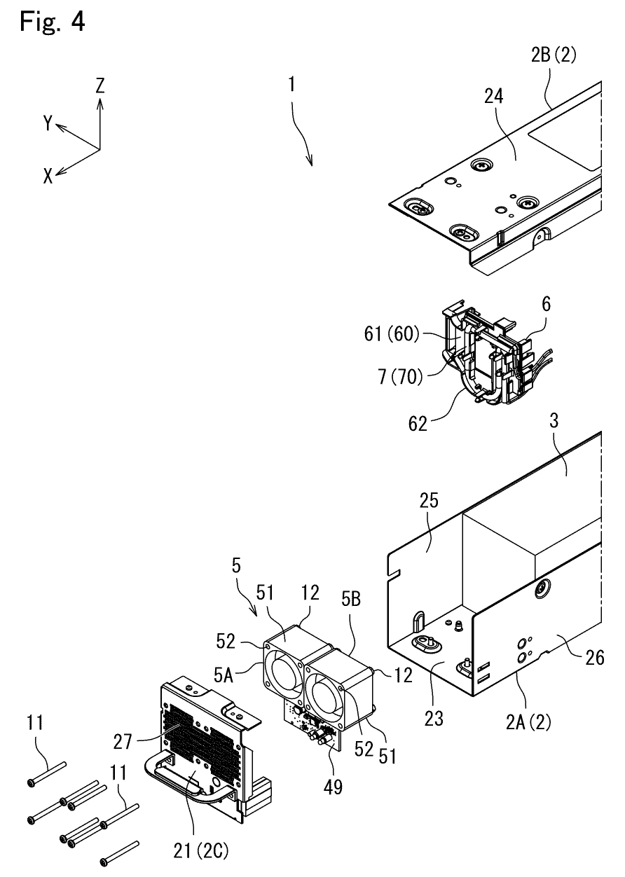

Referring to FIGS. 1 to 4, a battery module 1 according to a first embodiment includes an exterior casing 2, a battery assembly 3, a fan 5, a standing wall 6, and a leakage sensor 7. The battery module 1 further includes a circuit unit 4.

The exterior casing 2 has a rectangular parallelepiped shape, and has a rectangular shape in a view in the height direction Z (that is, in a plan view). In the following description, the direction in which the long sides of the rectangle extend will be referred to as a longitudinal direction X, and the direction in which the short sides extend will be referred to as a width direction Y. Each of the longitudinal direction X, the width direction Y, and the height direction Z is orthogonal to the other two directions.

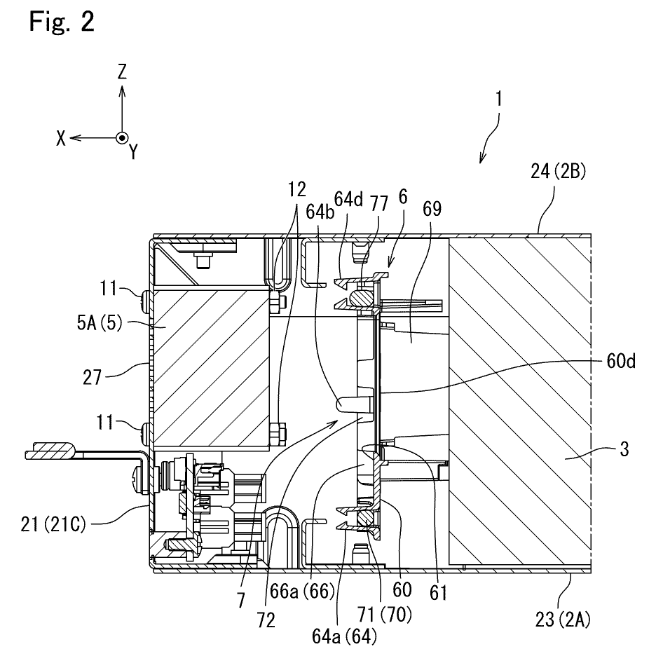

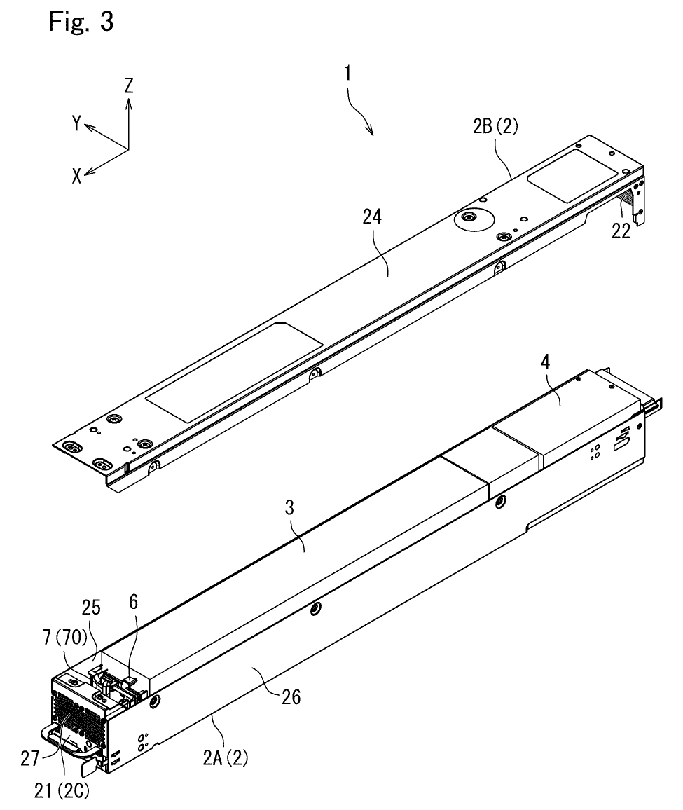

The exterior casing 2 includes a first end wall 21 and a second end wall 22 facing each other in the longitudinal direction X, a bottom wall 23 and a top wall 24 facing each other in the height direction Z, and a first side wall 25 and a second side wall 26 facing each other in the width direction Y. The exterior casing 2 defines the internal space surrounded by these walls. The first end wall 21 extends upward from an end of the bottom wall 23, and connects to an end of the top wall 24, on one side in the longitudinal direction X (on the lower left side in FIGS. 1, 3, and 4, on the left side in FIG. 2). The second end wall 22 connects the bottom wall 23 and the top wall 24, on the other side in the longitudinal direction X (on the upper right side in FIGS. 1 and 3). The first side wall 25 connects the first end wall 21 and the second end wall 22, on one side in the width direction Y (on the upper left side in FIGS. 1 and 3). The second side wall 26 connects the first end wall 21 and the second end wall 22, on the other side in the width direction Y (on the lower right side in FIGS. 1 and 3).

The exterior casing 2 has an inlet 27 provided to the first end wall 21, and an outlet 28 provided to the second end wall 22. Each of the inlet 27 and the outlet 28 is configured as a plurality of through holes, and communicably connects the internal space of the exterior casing 2 to the outside, so that the air for cooling the electric components in the exterior casing 2 is passed therethrough.

The exterior casing 2 includes, as components thereof, a base 2A and a cover 2B that are separatable in the height direction Z. The base 2A forms at least the bottom wall 23, and, in this example, also forms the first side wall 25 and the second side wall 26. The cover 2B forms at least the top wall 24. In this embodiment, the exterior casing 2 also includes, as a component thereof, an end plate 2C forming the first end wall 21. However, the way in which the exterior casing 2 is split to components may be changed as appropriate. The second end wall 22 may be integrated with the base 2A, may be integrated with the cover 2B, or may be included in a component other than the base 2A and the cover 2B.

The fan 5, the leakage sensor 7, the standing wall 6, the battery assembly 3, and the circuit unit 4 are housed inside the exterior casing 2, from one side to the other side in the longitudinal direction X, in the order listed herein.

The battery assembly 3 includes a plurality of battery cells (not illustrated), and a cell holder 31 that holds the plurality of battery cells in place. As an example, the battery cell is a non-aqueous electrolyte secondary battery such as a lithium ion battery, and has a cylindrical container. However, the battery cell may be a battery other than a cylindrical type such as a square type, as an example, or may be a battery other than a lithium ion battery, e.g., an all-solid battery, as another example.

The cell holder 31 has a substantially rectangular parallelepiped shape, as a whole. Although not illustrated in detail, the plurality of battery cells are held in vertical orientations, with the axial directions thereof directed toward the height direction Z. The cell holder 31 has a plurality of housing portions where the plurality of respective battery cells are housed individually. Each of the housing portions has a cylindrical shape, so as to house a battery cell corresponding thereto. Some of the housing portions may be exposed from both of the end surfaces of the cell holder 31 in the longitudinal direction X and both of the side surfaces in the width direction Y, the end surfaces and side surfaces delineating the outline of the area where the battery cells are disposed, in a plan view. In such a case, with the outer peripheral surfaces of such housing portions, the cell holder 31 has an uneven surface.

Note that the battery assembly 3 may include a current-collecting structure and a heat transfer structure (not illustrated). The current-collecting structure may have a lead plate made of a conductive material, in order to electrically connect the battery cells. The heat transfer structure may include a sheet or plate made of a thermally conductive material, so that the heat of the battery cells is deprived thereby. These structures are placed on the top surface or the bottom surface of the cell holder 31.

The circuit unit 4 may include a monitoring module for monitoring the conditions of the battery cells, a charging/discharging control module for controlling to charge and to discharge the battery cells, a voltage converter module for converting (e.g., stepping down, stepping up, or both) the DC voltage received from the battery cells or sent to the battery cells, or a fan control module for controlling the volume of the airflow to be sent out from the fan 5 depending on the conditions of the battery cells (e.g., temperature). The modules described herein as an example may be partly mounted on a substrate 49 disposed independently from the circuit unit 4, at another place (e.g., a space between the battery assembly 3 and the first end wall 21, or a space between the battery assembly 3 and the first side wall 25 or the second side wall 26). When the leakage sensor 7 detects the ingress of liquid, the charging/discharging control module and the voltage converter module stop some or all of their functions.

Merely as an example, the fan 5 includes a first fan 5A and a second fan 5B disposed side by side along the width direction Y. The first fan 5A is an axial fan, as an example. The first fan 5A includes a fan frame 51 having a rounded square shape in a view in the axial direction, four bolt insertion holes 52 provided at four respective corners of the fan frame 51, and an impeller (not illustrated in detail) rotatably supported at the center of the fan frame 51. When the impeller is rotated, the first fan 5A is caused to suction the air from the rear side of the fan, and blows out the air toward the front side of the fan. The second fan 5B has the same configuration as that of the first fan 5A.

The fan 5 is mounted on the inner surface of the first end wall 21. More specifically, the rear surface (the suction-side end surface) of the first fan 5A is positioned facing the inner surface of the first end wall 21, in a manner covering the inlet 27. Four bolts 11 are inserted from the outer surface side to the other side of the first end wall 21 in the longitudinal direction X, into the four bolt insertion holes 52, respectively, and are screwed with nuts 12, respectively, that are provided on the front surface side of the fan 5 (on the discharge-side end surface). The second fan 5B is fastened to the first end wall 21 in the same manner. The first fan 5A and the second fan 5B are disposed adjacently to each other in the width direction Y, and together cover the inner surface, particularly, an upper half, of the first end wall 21.

The fan 5 generates an airflow flowing along the axial direction thereof. The axial direction of the fan 5 corresponds to the longitudinal direction X of the battery module 1. The upstream side in the direction of the airflow corresponds to one side in the longitudinal direction X, and the downstream side corresponds to the other side in the longitudinal direction X. The air immediately after passing through the inlet 27 is suctioned into the fan 5, and blown out from the fan 5 into the exterior casing 2. The air cools the battery assembly 3 and the circuit unit 4 while flowing through the exterior casing 2 toward the other side in the longitudinal direction X. The air flows out of the exterior casing 2 through the outlet 28.

While the battery module 1 is in use, the outer surface of the exterior casing 2 may become wet. As an example, one or more battery modules 1 may be disposed side by side with external electronic devices on a shelf, so as to serve as a function as a BBU, and such electronic devices may be cooled by liquid cooling. In case there is a leakage of coolant from the liquid-cooling system, the coolant may drip onto the outer surface of the top wall 24 of the exterior casing 2. Examples of the coolant (that is, the liquid that can attach to the exterior casing 2) include pure water, an ethylene glycol aqueous solution, and a propylene glycol aqueous solution.

With the action of the fan 5, the liquid (e.g., water) having wetted the outer surface of the exterior casing 2 may be pulled toward the first end wall 21, and go into the exterior casing 2 through the inlet 27. The ingress liquid passes through the inlet 27, the fan rear surface, and the fan frame 51, one after another, and is blown out of the fan front surface, by being carried by the airflow.

The leakage sensor 7 is, for example, a cord sensor or a rope sensor. The leakage sensor 7 includes a detection cord 70 which is long and flexible and has a string-like, rope-like, or belt-like shape. When liquid (e.g., water) touches the detection cord 70, the liquid permeates into the detection cord 70, and two electrode wires (not illustrated) inside the detection cord 70 are short-circuited via the liquid. By electrically detecting this short circuit, the leakage sensor 7 detects that there is liquid around the leakage sensor 7. With the leakage sensor 7 housed inside the exterior casing 2 where there is originally no liquid, the detection of the presence of liquid means the detection of ingress of liquid into the exterior casing 2.

The rear side of the fan 5 is in contact with the inner surface of the first end wall 21, or faces the inner surface of the first end wall 21 with a slight clearance therebetween. This enables compression of the space behind the fan, so that the volume energy density of the battery module 1 can be improved. By contrast, if the clearance between the rear side of the fan and the first end wall 21 is too small, there would be no room for providing the leakage sensor 7 on the path of the ingress liquid (e.g., between the inlet 27 and the rear surface of the fan). In order to enable the leakage sensor 7 to detect ingress of liquid, it is necessary to dispose the leakage sensor 7 in front of the fan in the exterior casing 2 so that the largest possible amount of blown-out liquid carried along the airflow is brought into contact with the leakage sensor 7.

The particle size of the liquid blown out of the fan 5 can vary depending on the amount of the ingress liquid (on the flow rate of ingress liquid per unit time, in particular). When the amount of ingress liquid is small, liquid comes to have small particle diameters, becomes atomized, and is scattered by the fan 5. Therefore, the amount of liquid actually attaching to the leakage sensor 7 is even smaller than that of the ingress liquid, which is small to start with. Even if a part of the mist is directly blown against the leakage sensor 7, the amount of liquid attached per unit area will be extremely small. This makes the detection of ingress of liquid difficult, because no part of the detection cord 70 is short-circuited sufficiently.

To address this issue, the battery module 1 includes the standing wall 6 to maintain or to improve the detection accuracy of ingress of the liquid, even with the leakage sensor 7 disposed in front of the fan. In this embodiment, the standing wall 6 is configured as a component separate from the battery assembly 3, more specifically, a component separate from the cell holder 31.

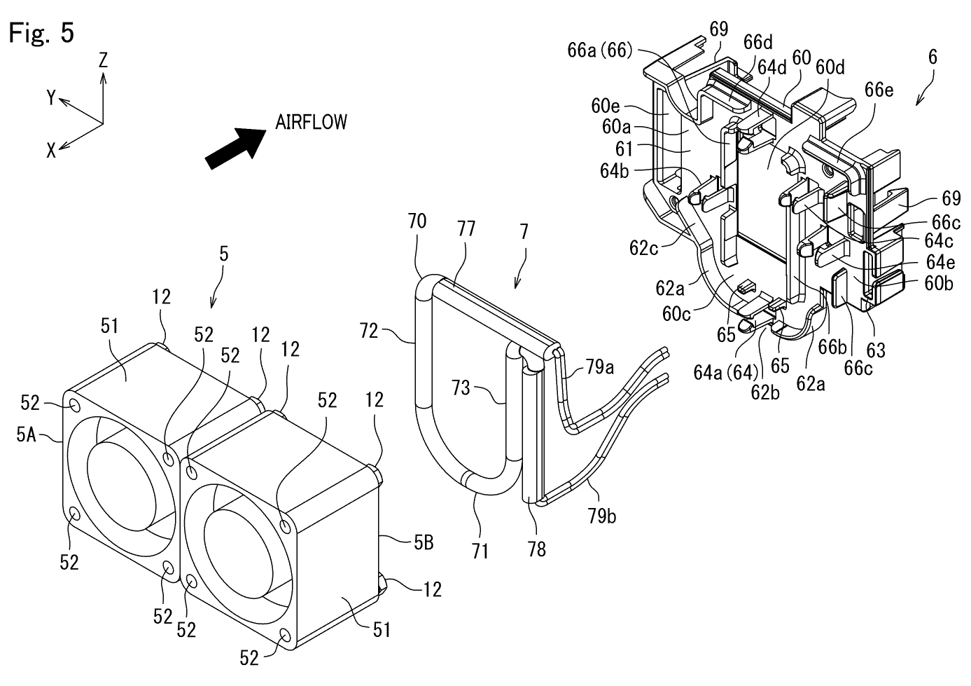

A structure and an arrangement of the standing wall 6 and the leakage sensor 7 will now be explained further with reference to FIGS. 5 to 7.

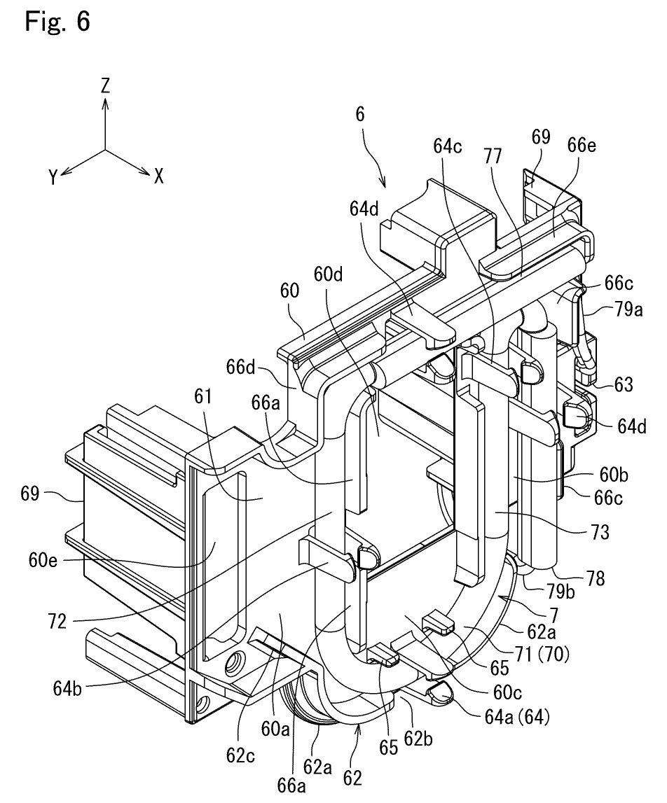

The standing wall 6 has a base plate 60 extending in the width direction Y and the height direction Z. Of a pair of surfaces of the base plate 60, the one side surface in the longitudinal direction X (the lower left side in FIG. 5 and the lower right side in FIG. 6) is a facing surface 61 disposed in a manner facing the fan 5 in the longitudinal direction X (that is, in the direction of the airflow or the axial direction of the fan). The facing surface 61 is a flat surface. The normal line of the facing surface 61 is directed along the longitudinal direction X.

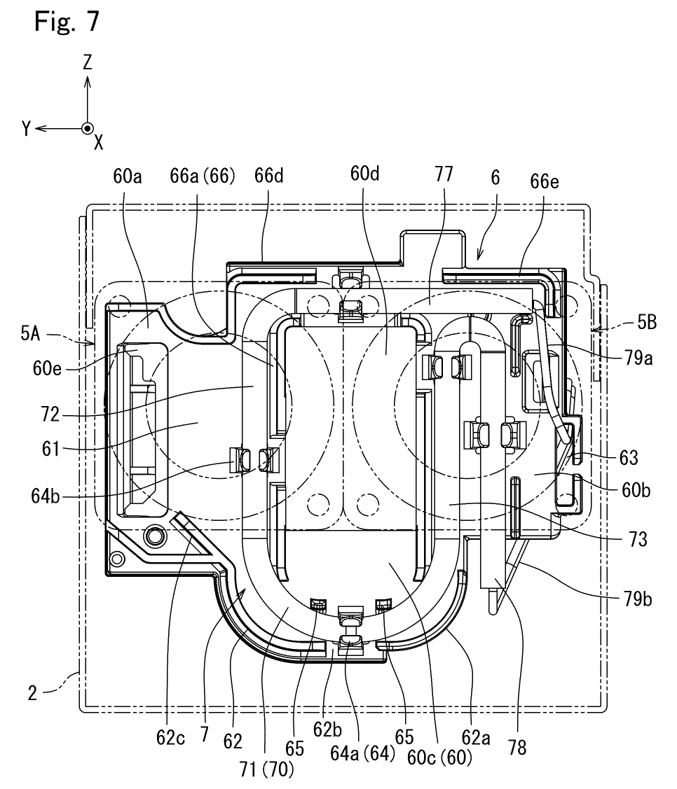

The base plate 60 includes a center part 60c in the width direction Y, a first extending part 60a projecting from the center part 60c toward the one side in the width direction Y (on the upper left side in FIG. 5, on the lower left side in FIG. 6, or on the left side in FIG. 7), and a second extending part 60b projecting from the center part 60c toward the other side in the width direction Y (on the lower right side in FIG. 5, upper right side in FIG. 6, or the right side in FIG. 7).

The center part 60c is projecting downward, with respect to the first extending part 60a and the second extending part 60b. The bottom edge of the first extending part 60a and the bottom edge of the second extending part 60b extend linearly in the width direction Y. The bottom edge of the second extending part 60b is positioned slightly higher than the bottom edge of the first extending part 60a.

The center part 60c is provided with a through hole 60d. As an example, the through hole 60d has a rectangular shape, and the edges along a pair of long sides of the rectangle extend in parallel with the height direction Z in a manner spaced apart from each other in the width direction Y, and the edges along a pair of short sides extend in parallel with the width direction Y in a manner spaced apart from each other in the height direction Z. An electronic component such as a fuse may be disposed inside the through hole 60d.

The first extending part 60a is also provided with a through hole 60e. The standing wall 6 is integrally provided with side walls 69 protruding from the respective edges of the base plate 60 in the width direction Y, toward the other side in the longitudinal direction X (upper right side of FIG. 5 or upper left side of FIG. 6). The through hole 60e has a shape provided for the purpose of forming the side walls 69. The side walls 69 are used for fixing to the cell holder 31 by snap-fitting, for example.

The standing wall 6 has a guide rib 62 protruding toward the fan 5, on the lower part of the facing surface 61. The guide rib 62 mainly serves as guiding and accumulating the droplets having attached to pthe facing surface 61.

The guide rib 62 includes a curved rib 62a having a downward curve curving toward a center of the facing surface 61, the center being the center in the width direction Y.

The curved rib 62a has a shape of an inverted semicircle in a view along the longitudinal direction X, with the bottom end thereof positioned at the center in the width direction Y, and with a pair of top ends positioned opposing each other in the width direction Y with respect to the bottom end. The curved rib 62a has a shape of a semicircle elongated in the width direction Y. In other words, the height of the curved rib 62a (the distance between the top ends and the bottom end in the height direction Z) is shorter than the width of the curved rib 62a (the distance between the pair of top ends in the width direction Y).

The curved rib 62a protrudes toward the one side in the longitudinal direction X, from the edge of the downward-projecting portion of the center part 60c of the base plate 60. The downward-projecting part is a part projecting downward, with respect to the first extending part 60a and the second extending part 60b, as mentioned earlier. The bottom end of the curved rib 62a is positioned at the bottom end of the entire standing wall 6, and is positioned at the center of the entire standing wall 6 in the width direction Y.

In this embodiment, a cutout 62b is provided at the bottom end of the curved rib 62a, and the cutout 62b splits the curved rib 62a into a pair of rib parts in the width direction Y. Each of the rib parts has a shape of a quarter arc that is elongated in the width direction Y, in a view in the longitudinal direction X, and delineates a downward curve curving toward the center in the width direction Y.

The guide rib 62 also includes an inclined rib 62c inclined downward toward the center in the width direction Y, and continuing to the top end of the curved rib 62a.

In this embodiment, one inclined rib 62c is provided continuously to the top end of the curved rib 62a (that is, to the top end of the rib part on the one side in the width direction Y), on the one side in the width direction Y. On the other side in the width direction Y, the guide rib 62 terminates at the top end of the curved rib 62a on the other side in the width direction Y, and, on the one side in the width direction Y, terminates at the top end of the inclined rib 62c.

The inclined rib 62c extends from a lower corner of the first extending part 60a on the side near the center in the width direction Y, upward toward the one side in the width direction Y. The inclined rib 62c is provided to the bottom end of the first extending part 60a. The inclined rib 62c extends linearly. The top end of the inclined rib 62c reaches near the edge or the corner of the through hole 60e.

The leakage sensor 7 extends along the facing surface 61 of the standing wall 6, and at least a part thereof is disposed in a manner following the guide rib 62. The leakage sensor 7 includes a long and flexible detection cord 70.

The detection cord 70 includes two electrode wires, inner braids surrounding the respective electrode wires, and an outer braid surrounding the entire two electrode wires each surrounded by the inner braid, not illustrated in detail. The outer braid and the inner braids are made of synthetic fibers such as those made of polyester and polyethylene, and enable the liquid, when the liquid becomes attached to the outer surface of the detection cord 70, to reach the electrode wires. As the two electrode wires are short-circuited by the liquid, the leakage sensor 7 detects the liquid on the basis of a change in the resistance between the electrode wires.

With the leakage sensor 7 assembled to the standing wall 6, the detection cord 70 delineates a U shape in a view in the longitudinal direction X, and includes a laterally extending part 71, a first vertically extending part 72, and a second vertically extending part 73. The laterally extending part 71 extends along the bottom edge of the facing surface 61 in the width direction Y. The first vertically extending part 72 extends upward from the one side of the laterally extending part 71 in the width direction Y. The second vertically extending part 73 extends upward from the other side of the laterally extending part 71 in the width direction Y.

The ends of the detection cord 70 are connected to respective signal lines 79a, 79b. The signal line 79a is electrically and mechanically connected to the two electrode wires in the detection cord 70, by welding. The same applies to the signal line 79b.

The battery module 1 includes a first sleeve 77 for protecting the connection between an end of the first vertically extending part 72 (that is, one end of the detection cord 70) and the signal line 79a, and a second sleeve 78 for protecting a connection between an end of the second vertically extending part 73 (that is, the other end of the detection cord 70) and the signal line 79b. Each of the first sleeve 77 and the second sleeve 78 has a cylindrical shape having a diameter larger than that of the detection cord 70, and is wound around the connection corresponding thereto.

The laterally extending part 71 is disposed along the inner surface of the curved rib 62a. The laterally extending part 71 delineates a semicircular shape that is convex downward in a view in the longitudinal direction X, following the shape of the curved rib 62a.

The first vertically extending part 72 extends in the vertical direction along the edge of the long side of the through hole 60d, near the boundary between the center part 60c and the first extending part 60a. The upper end of the first vertically extending part 72 is bent at a right angle in a manner being directed toward the other side in the width direction Y, near the upper edge of the facing surface 61.

The first sleeve 77 extends linearly from the end of the first vertically extending part 72 toward the other side in the width direction Y, along the upper edge of the facing surface 61 and the upper edge of the through hole 60d. The first sleeve 77 extends to reach the second extending part 60b. The signal line 79a extends downward from an end of the first sleeve 77 on the other side in the width direction Y, along the facing surface 61 of the second extending part 60b, passes through a wiring slot 63, and then extends toward the other side in the longitudinal direction X. The wiring slot 63 is provided to the side wall 69 that is on the other side in the width direction Y.

The second vertically extending part 73 extends in the vertical direction along the edge of the long side of the through hole 60d near the boundary between the center part 60c and the second extending part 60b. The upper end of the second vertically extending part 73 makes a downward turn, in a hairpin-like shape. This turn is positioned immediately below the first sleeve 77.

The second sleeve 78 extends linearly downward from an end of the second vertically extending part 73, adjacently to the second vertically extending part 73 on the other side in the width direction Y. The second sleeve 78 is disposed along the facing surface of the second extending part 60b, and the bottom end of the second sleeve 78 extends below the bottom edge of the second extending part 60b. The signal line 79b extends from the bottom end of the second sleeve 78 toward the other side in the longitudinal direction X.

The standing wall 6 also includes a sensor clamp 64, a sensor hook 65, and a sensor guide 66. The sensor clamp 64, the sensor hook 65, and the sensor guide 66 also protrude from the facing surface 61 toward the fan 5, in the same manner as the guide rib 62. The sensor clamp 64, the sensor hook 65, and the sensor guide 66 mainly serves as holding the leakage sensor 7 at a fixed position along the facing surface 61.

The sensor clamp 64 includes a pair of locking pieces projecting out from the facing surface 61, and the pair of locking pieces is provided with claws protruding in directions approaching each other, at the respective tips thereof. The sensor clamp 64 includes a bottom clamp 64a, a first side clamp 64b, a second side clamp 64c, a first sleeve clamp 64d, and a second sleeve clamp 64e.

The bottom clamp 64a is disposed inside the cutout 62b, and nips the center part of the laterally extending part 71 in the width direction Y. The first side clamp 64b is provided near the boundary between the center part 60c and the first extending part 60a, and nips the center part of the first vertically extending part 72 in the height direction Z. The second side clamp 64c is provided near the boundary between the center part 60c and the second extending part 60b, and nips the base of the hairpin-shaped part of the second vertically extending part 73. The first sleeve clamp 64d is disposed between the upper edge of the through hole 60d and the upper edge of the facing surface 61, and nips the first sleeve 77. The second sleeve clamp 64e is disposed at the center of the second extending part 60b in both of the height direction Z and the width direction Y, and nips the second sleeve 78.

The sensor hook 65 includes one locking piece projecting out from the facing surface 61. The sensor hooks 65 are disposed on the respective sides of the bottom clamp 64a in the width direction Y, and hold down the laterally extending part 71 from above. The posture and the position of the laterally extending part 71 are thus restrained so that the laterally extending part 71 passes through a narrow space between the sensor hook 65 and the curved rib 62a.

The sensor guide 66 is provided as a ridge or a rib projecting out from the facing surface 61. The sensor guide 66 includes a first side guide 66a, a second side guide 66b, a third side guide 66c, a first top guide 66d, and a second top guide 66e.

The first side guide 66a extends in the height direction Z along the side edge of the through hole 60d on the one side in the width direction Y. The first vertically extending part 72 is disposed along the first side guide 66a, and is thus held in a posture extending in the height direction Z and at a position near the through hole 60d. The second side guide 66b extends in the height direction Z along the side edge of the through hole 60d on the other side in the width direction Y. The second vertically extending part 73 is disposed along the second side guide 66b, and is thus held in a posture extending in the height direction Z and at a position near the through hole 60d.

The first top guide 66d and the second top guide 66e extend in the width direction Y along the upper edge of the facing surface 61. The first top guide 66d is disposed on the one side of the first sleeve clamp 64d in the width direction Y, and guides the upper end of the first vertically extending part 72 to bend perpendicularly. The second top guide 66e is provided to the second extending part 60b, guides the tip of the first sleeve 77, and guides the signal line 79a to extend downward.

The third side guide 66c extends in the height direction Z along a center part of the second extending part 60b in the width direction Y. The upper part of the third side guide 66c guides the second vertically extending part 73 to bend in the hairpin-like shape, and the lower part of the third side guide 66c guides the second sleeve 78 to extend downward.

Referring to FIG. 7, the axial center of the first fan 5A passes through the first extending part 60a. The axial center of the second fan 5B passes through the second extending part 60b. The facing surface 61 of the first extending part 60a receives the liquid blown out of the first fan 5A. The facing surface 61 of the second extending part 60b receives the liquid blown out of the second fan 5B.

When there is a large amount of ingress liquid (when the ingress flow rate per unit time is high), the liquid is blown against the facing surface 61 as airborne droplets having some particle sizes. When the fan 5 generates a high volume of airflow, airborne droplets of the liquid fly along the longitudinal direction X. A sufficient amount of liquid for short-circuiting the electrode wire in the detection cord 70 thus becomes attached to the first vertically extending part 72 and the second vertically extending part 73. Therefore, when there is a large amount of ingress liquid, particularly when the fan 5 generates a high volume of airflow, ingress of liquid can be detected quickly and accurately.

When there is a large amount of ingress liquid, and the fan 5 generates a low volume of airflow, airborne droplets of liquid fly in the longitudinal direction X while falling. Therefore, the airborne droplets of liquid are received on the lower parts of the first extending part 60a and the second extending part 60b. The liquid received on the facing surface 61 forms droplets on the facing surface 61. The droplets flow down along the facing surface 61 by their own weights, while gathering droplets attached to the lower part of the facing surface 61.

In this embodiment, the standing wall 6 is configured as a separate component that is separate from the battery assembly 3. Therefore, the facing surface 61 can be easily provided with a flat surface. In comparison with a configuration with an irregular facing surface 61, it is easier to control the direction in which the droplets flow down.

The droplets having attached to the facing surface 61 of the first extending part 60a reach the inner surface of the inclined rib 62c. Because the tip of the inclined rib 62c is positioned near to the edge or corner of the through hole 60e, the inclined rib 62c can capture substantially the entire amount of droplets attached to the first extending part 60a. The droplets are guided downward along the inclination of the inclined rib 62c, toward the center in the width direction Y, and reach the inner surface of the curved rib 62a. The curved rib 62a has a semicircular shape, and a tangent line at a connection point between the curved rib 62a and the inclined rib 62c extends substantially vertically downward. Upon reaching the curved rib 62a, the droplets quickly flow downward. In the lower part of the curved rib 62a, the droplets flow quickly toward the center in the width direction Y, as the potential energy is converted into the kinetic energy. In this manner, droplets attached to the first extending part 60a are collected to the bottom end of the curved rib 62a.

Near the bottom end of the curved rib 62a, the center part of the laterally extending part 71 in the width direction Y is held by the bottom clamp 64a and the sensor hook 65. The droplets collected to the bottom end of the curved rib 62a permeate into the center part of the laterally extending part 71 in the width direction Y. Due to the liquid-accumulating effect of the guide rib 62, a sufficient amount of liquid for short-circuiting of the electrode wire becomes attached to the laterally extending part 71. Therefore, even when the fan 5 generates a low volume of airflow, ingress of liquid can be detected accurately.

The same applies even when the amount of ingress liquid is small. When the amount of ingress liquid is small, liquid comes to have small particle diameters, and becomes atomized. Although the atomized liquid can become attached to the first vertically extending part 72 and the second vertically extending part 73 directly, a sufficient amount of liquid for short-circuiting the electrode wires may not be achieved. However, with the facing surface 61, even the atomized liquid can be received. The received liquid forms droplets, in the same manner as described above. The subsequent behaviors of the droplets are the same as those described above. The liquid becomes collected to the bottom end of the curved rib 62a, so that a sufficient amount of liquid for short-circuiting the electrode wires is allowed to attach to the laterally extending part 71. Therefore, although it may take longer time to detect ingress of liquid, compared with that in the case where there is a large amount of ingress liquid and where a high volume of airflow is generated by the fan 5, the ingress of liquid can be detected accurately, even with such a small amount of ingress liquid.

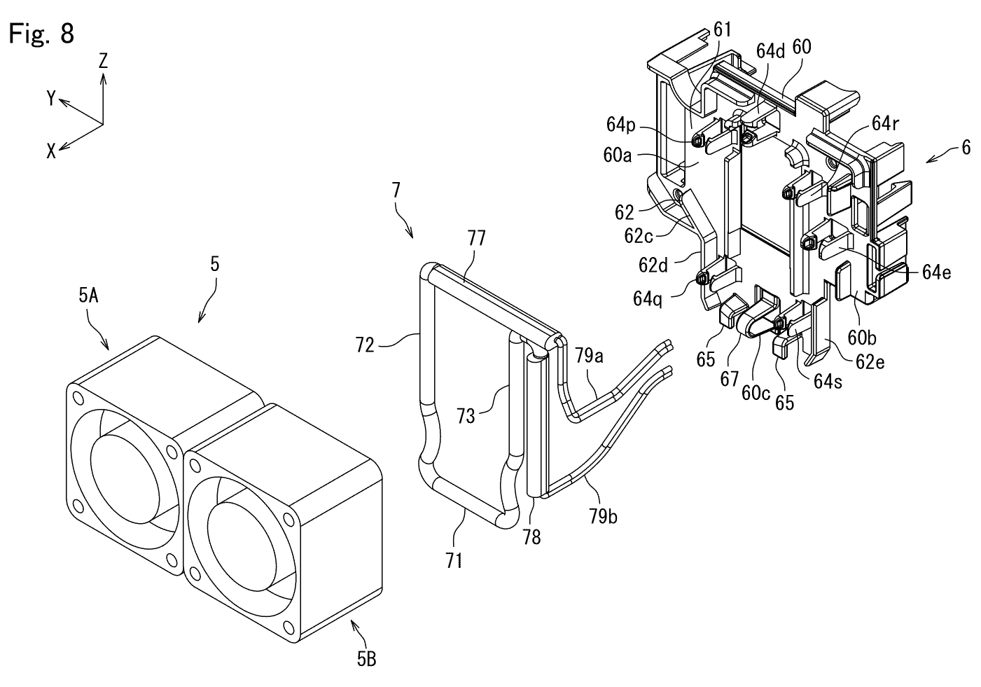

A battery module 1 according to a second embodiment will be described with reference to FIGS. 8 to 10, with a focus on the differences with respect to the first embodiment.

In this embodiment, the curved rib 62a and the cutout 62b (see FIGS. 5 to 7) in the first embodiment are omitted. With the curved rib 62a omitted, the downward-projecting portion of the center part 60c of the base plate 60 has a rectangular shape in a view in the longitudinal direction X. In replacement of the omitted curved rib 62a, the guide rib 62 includes a first vertical rib 62d and a second vertical rib 62e extending in the height direction Z, in a manner spaced apart from each other in the width direction Y.

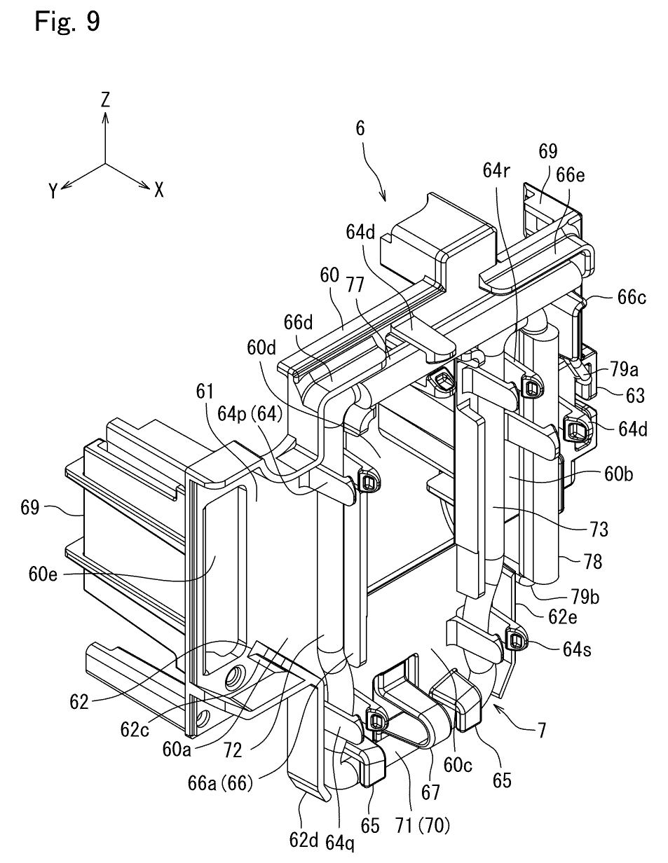

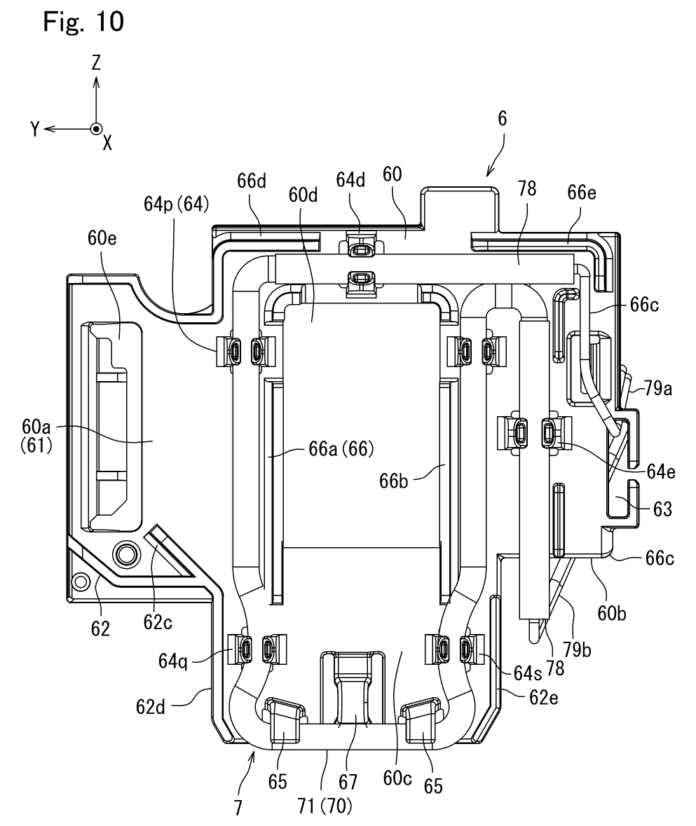

The first vertical rib 62d projects out, toward the one side in the longitudinal direction X (toward the lower left side in FIG. 8 and toward the lower right side in FIG. 9), from a side edge of the downward-projecting portion at the center part 60c of the base plate 60, the side edge being an edge on the one side in the width direction Y (on the upper left side in FIG. 8, the lower left side in FIG. 9, or the left side in FIG. 10). The second vertical rib 62e projects out toward the one side in the longitudinal direction X, from a side edge of the downward-projecting portion at the center part 60c of the base plate 60, on the other side in the width direction Y (on the lower right side in FIG. 8, the upper right side in FIG. 9, or the right side in FIG. 10).

In the first embodiment (see FIGS. 5 to 7), the laterally extending part 71 is disposed along the curved rib 62a. In this embodiment, with the curved rib 62a omitted, the laterally extending part 71 extends linearly in the width direction Y, along the bottom edge of the center part 60c. The bottom ends of the first vertically extending part 72 and the second vertically extending part 73 reach the bottom end of the center part 60c, and continue to the laterally extending part 71, instead. The first vertically extending part 72 is disposed along the inner surface of the first vertical rib 62d. The second vertically extending part 73 is disposed along the inner surface of the second vertical rib 62e.

In this embodiment, the battery module 1 includes an elastic support body 67, instead of the bottom clamp 64a (see FIGS. 5 to 7) according to the first embodiment. The elastic support body 67 is provided to the bottom end of the center part 60c, and elastically supports the laterally extending part 71 from above. The pair of sensor hooks 65 further includes hanging pieces, respectively, hanging down from the tips of the respective locking pieces. The laterally extending part 71 is held in a space surrounded by the locking pieces and the hanging pieces of the sensor hooks 65.

In this embodiment, with the curved rib 62a omitted, the bottom end of the inclined rib 62c is continuous with the top end of the first vertical rib 62d.

In this embodiment, upper and lower first side clamps are provided as a pair, and upper and lower second side clamps are provided as a pair. The sensor clamp 64 includes an upper first side clamp 64p, a lower first side clamp 64q, an upper second side clamp 64r, and a lower second side clamp 64s.

The upper first side clamp 64p nips the base end of the perpendicularly bent portion of the first vertically extending part 72. The upper second side clamp 64r is positioned and configured similarly to the second side clamp 64c according to the first embodiment, and nips the base end of the hairpin-shaped part of the second vertically extending part 73.

The lower first side clamp 64q and the lower second side clamp 64s are provided to the downward-projecting portion of the center part 60c. The lower first side clamp 64q nips the bottom end of the first vertically extending part 72. The lower second side clamp 64s nips the bottom end of the second vertically extending part 73.

The lower first side clamp 64q is positioned slightly offset from the upper first side clamp 64p toward the center in the width direction Y. Consequently, the bottom end of the first vertically extending part 72 extends in a manner delineating a gently curved S shape. The first vertically extending part 72 is bulged out in the width direction Y, in the part continuous to the laterally extending part 71 (that is, the bottom end of the first vertically extending part 72), and is in contact with or near the inner surface of the first vertical rib 62d. The bottom end of the first vertical rib 62d has a downward inclination extending toward the center in the width direction Y. This inclination also contributes to the reduction in the distance between the inner surface of the first vertical rib 62d and the detection cord 70.

The relationship between the lower second side clamp 64s and the upper second side clamp 64r is also the same as described above. The second vertically extending part 73 extends in a manner delineating a gently curved S shape, in the bottom end thereof. The bottom end of the second vertical rib 62e has a downward inclination toward the center in the width direction Y. The bottom end of the second vertically extending part 73 is positioned in contact with or near the inner surface of the second vertical rib 62e.

Also in this embodiment, when the liquid is blown against the facing surface 61, the liquid forms droplets, on the facing surface 61. The droplets fall down along the facing surface 61. The droplets are guided by the guide rib 62 and flow downward along the lower surface of the first vertical rib 62d or the second vertical rib 62e. When the droplets reach the bottom ends of the first vertical ribs 62d and the second vertical ribs 62e, the droplets become attached to the detection cord 70. As a result, the leakage sensor 7 can detect the ingress of liquid accurately.

Although the embodiments have been described so far, the configurations described above are merely exemplary, and may be changed as appropriate, within the scope of the present disclosure.

A pair of inclined ribs 62c may be continuous with the pair of respective ends of the curved rib 62a (see the first embodiment) or the respective top ends of the pair of vertical ribs 62d and 62e (see the second embodiment).

It is also possible for the standing wall 6 not to be a dedicated part. For example, the standing wall 6 may be integrated with the cell holder 31.

This disclosure may involve the following aspects.

### Aspect 1

A battery module comprising:

an exterior casing;

a battery assembly that is housed in the exterior casing;

an inlet that is provided to an end wall of the exterior casing;

a fan that is mounted on an inner surface of the end wall, and that is configured to blow out air suctioned through the inlet into the exterior casing;

a standing wall that has a facing surface facing the fan, and a guide rib projecting from a lower part of the facing surface toward the fan; and

a leakage sensor extending along the facing surface, with at least a part of the leakage sensor disposed along the guide rib.

### Aspect 2

The battery module according to Aspect 1, wherein the leakage sensor includes a laterally extending part extending along a bottom edge of the facing surface in a width direction.

### Aspect 3

The battery module according to Aspect 2, wherein

the guide rib includes a curved rib curving downward toward a center of the facing surface in the width direction, and

the laterally extending part is provided along an inner surface of the curved rib.

### Aspect 4

The battery module according to Aspect 3, wherein the guide rib includes an inclined rib inclined downward toward the center in the width direction, and being continuous with a top end of the curved rib.

### Aspect 5

The battery module according to any one of Aspects 2 to 4, wherein the leakage sensor includes: a first vertically extending part extending upward from an end of the laterally extending part, on one side in the width direction; and a second vertically extending part extending upward from an end of the laterally extending part, on the other side in the width direction.

### Aspect 6

The battery module according to Aspect 5, wherein

the guide rib includes a first vertical rib and a second vertical rib that are spaced apart from each other in the width direction, and that extend in the vertical direction, and

the first vertically extending part is disposed along an inner surface of the first vertical rib, and the second vertically extending part is disposed along an inner surface of the second vertical rib.

### Aspect 7

The battery module according to Aspect 5 or 6, wherein

a first sleeve having a cylindrical shape is disposed around a connection between the first vertically extending part and a signal line,

an upper end of the first vertically extending part is bent toward the other side in the width direction, and

the first sleeve extends from the first vertically extending part to the other side in the width direction, along an upper edge of the facing surface.

### Aspect 8

The battery module according to Aspect 7, wherein

a second sleeve having a cylindrical shape is disposed around a connection between the second vertically extending part and a signal line,

an upper end of the second vertically extending part is folded downward, and

the second sleeve extends downward from the second vertically extending part, adjacently to the second vertically extending part on the other side in the width direction.

### Aspect 9

The battery module according to any one of Aspects 1 to 8, wherein the standing wall is a component separate from the battery assembly, and is interposed between the fan and the battery assembly.

What is claimed is:

1. A battery module comprising:
an exterior casing;
a battery assembly that is housed in the exterior casing;
an inlet that is provided to an end wall of the exterior casing;
a fan that is mounted on an inner surface of the end wall, and that is configured to blow out air suctioned through the inlet into the exterior casing;
a standing wall that has a facing surface facing the fan, and a guide rib projecting from a lower part of the facing surface toward the fan; and
a leakage sensor extending along the facing surface, with at least a part of the leakage sensor disposed along the guide rib.

2. The battery module according to claim 1, wherein the leakage sensor includes a laterally extending part extending along a bottom edge of the facing surface in a width direction.

3. The battery module according to claim 2, wherein
the guide rib includes a curved rib curving downward toward a center of the facing surface in the width direction, and
the laterally extending part is provided along an inner surface of the curved rib.

4. The battery module according to claim 3, wherein the guide rib includes an inclined rib inclined downward toward the center in the width direction, and being continuous with a top end of the curved rib.

5. The battery module according to claim 2, wherein the leakage sensor includes: a first vertically extending part extending upward from an end of the laterally extending part, on one side in the width direction; and a second vertically extending part extending upward from an end of the laterally extending part, on the other side in the width direction.

6. The battery module according to claim 5, wherein
the guide rib includes a first vertical rib and a second vertical rib that are spaced apart from each other in the width direction, and that extend in the vertical direction, and
the first vertically extending part is disposed along an inner surface of the first vertical rib, and the second vertically extending part is disposed along an inner surface of the second vertical rib.

7. The battery module according to claim 5, wherein
a first sleeve having a cylindrical shape is disposed around a connection between the first vertically extending part and a signal line,
an upper end of the first vertically extending part is bent toward the other side in the width direction, and
the first sleeve extends from the first vertically extending part to the other side in the width direction, along an upper edge of the facing surface.

8. The battery module according to claim 7, wherein
a second sleeve having a cylindrical shape is disposed around a connection between the second vertically extending part and a signal line,
an upper end of the second vertically extending part is folded downward, and
the second sleeve extends downward from the second vertically extending part, adjacently to the second vertically extending part on the other side in the width direction.

9. The battery module according to claim 1, wherein the standing wall is a component separate from the battery assembly, and is interposed between the fan and the battery assembly.
